(19) United States
(12) Patent Application Publication
(10) Pub. No.: US 2011/0181686 A1
(43) Pub. Date: Jul. 28, 2011

(54) FLOW CONTROL

(75) Inventors: Hyeonkuk Jeong, San Jose, CA (US); James Oliver Normile, Los Altos, CA (US); Joe S. Abuan, Milpitas, CA (US); Ryan R. Salsbury, San Francisco, CA (US)

(73) Assignees: Apple Inc., Cupertino, CA (US); Apple Computer, Inc.

(21) Appl. No.: 12/950,648

(22) Filed: Nov. 19, 2010

Related U.S. Application Data
(63) Continuation of application No. 10/379,011, filed on Mar. 3, 2003, now abandoned.

(51) Int. Cl. H04N 7/15

(52) U.S. Cl. 348/14.08; 348/E07.083

(57) ABSTRACT

A method, apparatus, system, and signal-bearing medium that in an embodiment determine at least one capability of a transfer of data, set at least one parameter that affects performance of the transfer to an initial state based on the capability, detect performance of the transfer, and modify the parameter based on the performance. In this way, the data transfer can adapt to changing capabilities of the network and the devices that send and receive the data.

### CLAIM OF PRIORITY

This application is a Continuation of and claims the benefit of priority under 35 U.S.C. § 120 to U.S. patent application Ser. No. 10/379,011, filed Mar. 3, 2003, which is hereby incorporated by reference herein in its entirety.

### LIMITED COPYRIGHT WAIVER

A portion of the disclosure of this patent document contains material to which the claim of copyright protection is made. The copyright owner has no objection to the facsimile reproduction by any person of the patent document or the patent disclosure, as it appears in the U.S. Patent and Trademark Office file or records, but reserves all other rights whatsoever.

### FIELD

This invention relates generally to flow control of data in a network and more particular to flow control in a changing environment.

### BACKGROUND

In the past, people met face-to-face when they wanted to communicate. But, in today's mobile, widely dispersed, and increasingly interconnected society, people often need to communicate with others who are far away. In order to facilitate this communication, video conferencing is gaining in popularity.

In video conferencing, both parties have a conferencing system that may include a microphone, a camera, and a video monitor, and the parties are connected to each other via a network. In this way, the parties can converse while viewing still or moving video images of each other. Video images contain a large amount of data, so the conferencing systems need substantial computational power to acquire the data from the camera, compress the data, interface with the network to send and/or receive the data, decompress received data, and/or render the data for display. In order to supply this computational power, video conferencing has conventionally been performed by dedicated conferencing systems over networks with known and stable characteristics. In this situation, the conferencing systems have sufficient computational power and network bandwidth to perform the required compression, decompression, network processing, media acquisition, and rendering.

But, dedicated conferencing systems and networks are expensive and wasteful of resources when they are not in use, so it is desirable to provide video conferencing over a shared network (e.g., an intranet or the Internet) using shared devices, e.g., personal computers that may also be used for other tasks simultaneous with the video conferencing. With a shared network and a shared device, the characteristics of the network and the computational capabilities of the shared device may vary over the time period of the video conference, which can cause erratic performance of the audio and video, leading to user dissatisfaction.

Although this erratic performance and resulting dissatisfaction is particularly acute during video conferencing, these problems can apply to any type of data transfer where the network and/or device capabilities can change over time.

### SUMMARY

A method, apparatus, system, and signal-bearing medium are provided that in an embodiment determine at least one capability of a transfer of data, set at least one parameter that affects performance of the transfer to an initial state based on the capability, detect performance of the transfer, and modify the parameter based on the performance. In this way, the data transfer can adapt to changing capabilities of the network and the devices that send and receive the data.

### BRIEF DESCRIPTION OF THE DRAWINGS

FIG. 1 depicts a block diagram of an example system for implementing an embodiment of the invention.

FIG. 2 depicts a flowchart of example processing, according to an embodiment of the invention.

### DETAILED DESCRIPTION

In the following detailed description of exemplary embodiments of the invention, reference is made to the accompanying drawings (where like numbers represent like elements), which form a part hereof, and in which is shown by way of illustration specific exemplary embodiments in which the invention may be practiced. These embodiments are described in sufficient detail to enable those skilled in the art to practice the invention, but other embodiments may be utilized and logical, mechanical, electrical, and other changes may be made without departing from the scope of the present invention. Different instances of the word “embodiment” as used within this specification do not necessarily refer to the same embodiment, but they may. The following detailed description is, therefore, not to be taken in a limiting sense, and the scope of the present invention is defined only by the appended claims.

In the following description, numerous specific details are set forth to provide a thorough understanding of the invention. It is understood, however, that the invention may be practiced without these specific details. In other instances, well-known circuits, structures, and techniques have not been shown in detail in order not to obscure the invention.

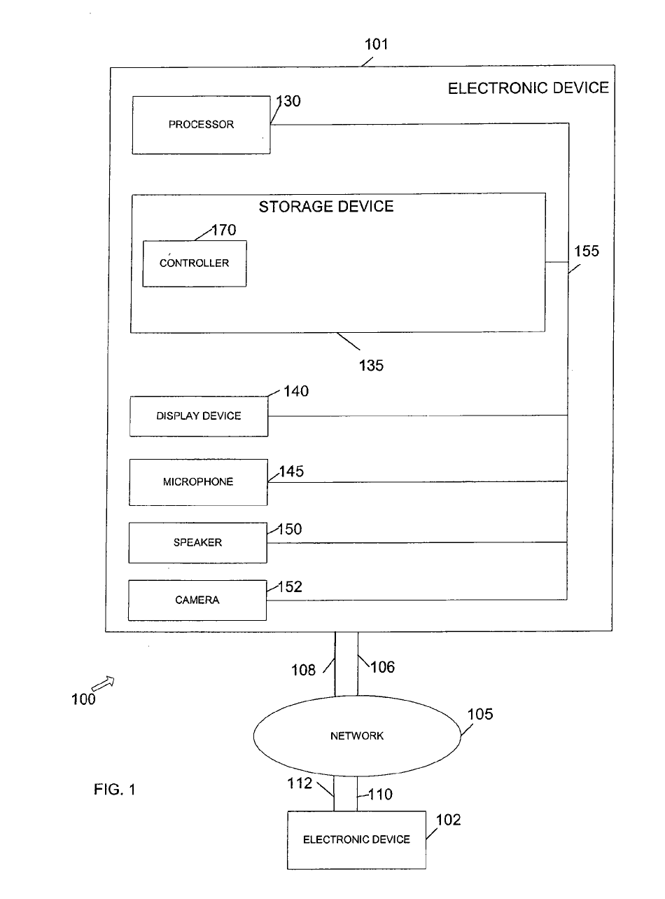

FIG. 1 depicts a block diagram of an example system for implementing an embodiment of the invention. A system 100 includes an electronic device 101 connected to an electronic device 102 via a network 105. Although one electronic device 101, one electronic device 102, and one network 105 are shown, in other embodiments any number or combination of them are present.

The electronic device 101 includes a processor 130, a storage device 135, a display device 140, a microphone 145, a speaker 150, and a camera 152, all connected directly or indirectly via a bus 155.

The processor 130 represents a central processing unit of any type of architecture, such as a CISC (Complex Instruction Set Computing), RISC (Reduced Instruction Set Computing), VLIW (Very Long Instruction Word), or a hybrid architecture, although any appropriate processor may be used. The processor 130 executes instructions and includes that portion of the electronic device 101 that controls the operation of the entire electronic device. Although not depicted in FIG. 1, the processor 130 typically includes a control unit that organizes data and program storage in memory and transfers data and other information between the various parts of the electronic device 101. The processor 130 receives input data from the network 105, the microphone 145, and/or the camera 152, reads and stores code and data in the storage device 135, and presents data to the network 105, the display device 140, and/or the speaker 150.

Although the electronic device 101 is shown to contain only a single processor 130 and a single bus 155, the present invention applies equally to electronic devices that may have multiple processors and to electronic devices that may have multiple buses with some or all performing different functions in different ways.

The storage device 135 represents one or more mechanisms for storing data. For example, the storage device 135 may include read only memory (ROM), random access memory (RAM), magnetic disk storage media, optical storage media, flash memory devices, and/or other machine-readable media. In other embodiments, any appropriate type of storage device may be used. Although only one storage device 135 is shown, multiple storage devices and multiple types of storage devices may be present. Further, although the electronic device 101 is drawn to contain the storage device 135, it may be distributed across other electronic devices.

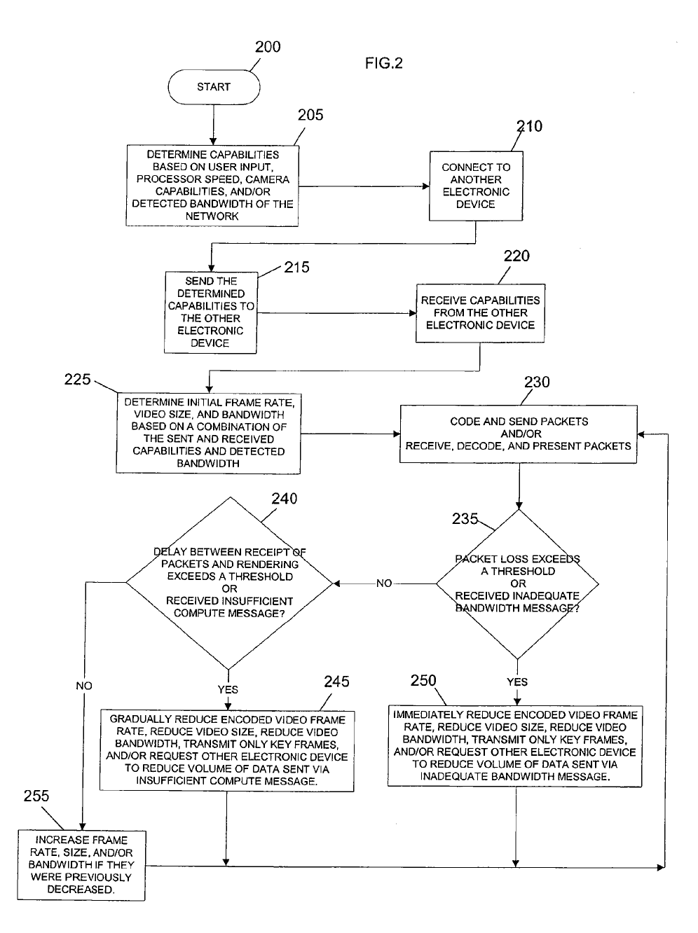

The storage device 135 includes a controller 170. The controller 170 includes instructions capable of being executed on the processor 130 to carry out the functions of the present invention, as further described below with reference to FIG. 2. In another embodiment, some or all of the functions of the present invention are carried out via hardware in lieu of a processor-based system. Of course, the storage device 135 may also contain additional software and data (not shown), which is not necessary to understanding the invention.

Although the controller 170 is shown to be within the storage device 135 in the electronic device 101, in another embodiment the controller 170 may be distributed across other systems.

The display device 140 displays video and/or still images to the user. The display device 140 may be a cathode-ray tube (CRT) based video display well known in the art of computer hardware. But, in other embodiments the display device 140 may be replaced with a liquid crystal display (LCD) based or gas, plasma-based, flat-panel display. In still other embodiments, any appropriate display device may be used. Although only one display device 140 is shown, in other embodiments, any number of display devices of different types or of the same type may be present.

The microphone 145 collects sound and transmits the sound to the controller 170 as data. Although only one microphone 145 is shown, in another embodiment any number and type of microphones may be present.

The speaker 150 presents audio output. Although only one speaker 150 is shown, in other embodiments any number and type of speakers may be present.

The camera 152 collects still or moving video data and presents the video data to the controller 170. Although only one camera 152 is shown, in other embodiments any number and type of cameras may be present.

The bus 155 may represent one or more busses, e.g., PCI, ISA (Industry Standard Architecture), X-Bus, EISA (Extended Industry Standard Architecture), or any other appropriate bus and/or bridge (also called a bus controller).

The electronic device 101 may be implemented using any suitable hardware and/or software, such as a personal computer or other electronic computing device. Portable computers, laptop or notebook computers, PDAs (Personal Digital Assistants), pocket computers, appliances, telephones, and mainframe computers are examples of other possible configurations of the electronic device 101. The hardware and software depicted in FIG. 1 may vary for specific applications and may include more or fewer elements than those depicted. For example, other peripheral devices such as audio adapters, or chip programming devices, such as EPROM (Erasable Programmable Read-Only Memory) programming devices may be used in addition to or in place of the hardware already depicted. Further, the electronic device 101 may include any number and type of input devices for receiving input from a user, e.g., a keyboard, mouse or other pointing device, or a voice-recognition device.

The network 105 may be any suitable network and may support any appropriate protocol suitable for communication between the electronic devices 101 and 102. In an embodiment, the network 105 may support wireless communications. In another embodiment, the network 105 may support hard-wired communications, such as a telephone line or cable. In another embodiment, the network 105 may support the Ethernet IEEE (Institute of Electrical and Electronics Engineers) 802.3x specification. In another embodiment, the network 105 may be the Internet and may support IP (Internet Protocol). In another embodiment, the network 105 may be a local area network (LAN) or a wide area network (WAN). In another embodiment, the network 105 may be a hotspot service provider network. In another embodiment, the network 105 may be an intranet. In another embodiment, the network 105 may be a GPRS (General Packet Radio Service) network. In another embodiment, the network 105 may be any appropriate cellular data network or cell-based radio network technology. In another embodiment, the network 105 may be an IEEE 802.11B wireless network. In still another embodiment, the network 105 may be any suitable network or combination of networks. Although one network 105 is shown, in other embodiments any number of networks (of the same or different types) may be present.

The electronic device 101 may have both a signaling channel 106 and a media (audio and/or video) channel to the network 105. Similarly, the electronic device 102 may have both a signaling channel 110 and a media channel to the network 105. Although the signaling channels and the media channels are drawn to be separate, in another embodiment they may be combined.

The electronic device 102 may include components analogous to some or all of the components already described for the electronic device 101.

As was described in detail above, aspects of an embodiment pertain to specific apparatus and method elements implementable on a computer or other electronic device. In another embodiment, the invention may be implemented as a program product for use with an electronic device. The programs defining the functions of this embodiment may be delivered to an electronic device via a variety of signal-bearing media, which include, but are not limited to:

(1) information permanently stored on a non-rewriteable storage medium, e.g., a read-only memory device attached to or within an electronic device, such as a CD-ROM readable by a CD-ROM drive;

(2) alterable information stored on a rewriteable storage medium, e.g., a hard disk drive or diskette; or

(3) information conveyed to an electronic device by a communications medium, such as through a computer or a telephone network, including wireless communications.

Such signal-bearing media, when carrying machine-readable instructions that direct the functions of the present invention, represent embodiments of the present invention.

FIG. 2 depicts a flowchart of example processing, according to an embodiment of the invention. Control begins at block 200. Control then continues to block 205 where the controller 170 determines a capability or capabilities of a transfer of data. In an various embodiments, the determined capabilities of the data transfer may be based on user input, the speed of the processor 130, the capabilities of the camera 152, and/or the bandwidth of the network 105.

Control then continues to block 210 where the controller 170 connects to another electronic device over the network 105, such as the electronic device 102. Control then continues to block 215 where the controller 170 sends the capabilities previously determined at block 205 to the electronic device 102. Control then continues to block 220 where the controller 170 receives capabilities from the electronic device 102 for the electronic device 102. The capabilities determined at block 205 and the capabilities received at block 220 together represent the determined initial capabilities for the data transfer.

Control then continues to block 225 where the controller 170 determines an initial frame rate, video size, and bandwidth based on a combination of the sent capabilities and the received capabilities and sets parameters for the frame rate, video size, and/or bandwidth to an initial state. These parameters will affect the data transfer when it is performed as further described below.

Control then continues to block 230 where the controller 170 performs the data transfer by coding and sending packets of audio and/or video data to the electronic device 102 using the parameters. In various embodiments, the controller 170 obtained the data from the microphone 145 and/or the camera 152, from the storage device 135, or from the network 105. In another embodiment, the controller 170 receives packets of data from the electronic device 102 via the network 105, decodes the data, and presents the data via the display device 140 and/or the speaker 150.

Control then continues to block 235 where the controller 170 detects the performance of the data transfer previously performed at block 230. The controller 170 also determines whether a packet loss during the data transfer exceeds a threshold or an inadequate bandwidth message has been received from the electronic device 102. If the determination at block 235 is false, then control then continues to block 240 where the controller 170 determines whether the delay between receipt of packets and rendering the packets exceeds a threshold or whether the controller 170 has received an insufficient compute message.

If the determination at block 240 is true, then control continues to block 245 where the controller 170 gradually and incrementally modifies the parameters based on the performance until the packet loss does not exceed the threshold. In various embodiments, the controller 170 incrementally reduces the encoded video frame rate, incrementally reduces the video size, incrementally reduces the video bandwidth, transmits only key frames, and/or requests the electronic device 102 to reduce the volume of data it is sending via a message that indicates that the electronic device 101 has insufficient computing power to handle the volume of data that the electronic device 101 is receiving. Control then returns to block 230 as previously described above.

If the determination at block 240 is false, then control continues to block 255 where the controller 170 increases the frame rate, size, and/or bandwidth if they were previously decreased. Control then returns to block 230, as previously described above.

If the determination at block 235 is true, then control then continues to block 250 where the controller 170 immediately modifies the parameters based on the performance to a point where the packet loss does not exceed the threshold. In various embodiments, the controller 170 immediately reduces the encoded video frame rate, immediately reduces the video size, immediately reduces the video bandwidth, transmits only key frames, and/or requests the electronic device 102 to reduce the volume of data it is sending via a message that indicates that the network 105 has inadequate bandwidth to handle the volume of data that the electronic device 102 is sending to the electronic device 101. Control then returns to block 230, as previously described above.

1. A method of controlling a transfer of video conferencing data over a network between at least two electronic devices, the method comprising the steps of:
setting at least one parameter to an initial state based on a set of capabilities for the transfer of video conferencing data between the at least two electronic devices, wherein the parameter affects the transfer;
detecting performance of the transfer by evaluating a first performance measure indicative of whether a delay between receipt of a packet of the data and subsequent rendering of the packet exceeds a threshold; and
modifying the at least one parameter based on the detected performance,

2. The method of claim 1, wherein the method further comprises:
subsequently repeating the detecting of the performance and modifying the at least one parameter based on the subsequently detected performance.

3. The method of claim 1, further comprising the step of determining the set of capabilities for the transfer of video conferencing data between the at least two electronic devices, said determining comprising at least one of:
receiving a user preference, determining a processor speed, determining a camera capability, wherein the camera supplies at least a portion of the data, and determining a bandwidth of a network over which the transfer occurs.

4. The method of claim 1, wherein the step of setting comprises at least one of:
setting an initial frame rate of the transfer, setting an initial video size, and setting an initial bandwidth of the transfer,

5. The method of claim I, wherein the step of modifying comprises at least one of:
changing an encoded video frame rate to a value that eliminates a congestion, changing a size of video to be encoded to a value that eliminates a congestion, and changing a bandwidth of video encoding to a value that eliminates a congestion.

6. The method of claim 1, wherein the set of capabilities for the transfer of video conferencing data. between the at least two electronic devices comprises:
a first set of one or more capabilities for the transfer of video conferencing data determined at a first electronic video conferencing device that is a party to the transfer;
a second set of one or more capabilities for the transfer of video conferencing data that is received at the first video conferencing electronic device from a second electronic device; and
wherein the second electronic device is a party to the transfer,

7. The method of claim 1, wherein the step of modifying comprises incrementally reducing the at least one parameter.

8. The method of claim 1, further comprising:
transmitting only keyframes of the data at the frame rate.

9. The method of claim 1, further comprising:
requesting a sending device to change a volume of the data. sent.

10. A method of controlling a transfer of video conferencing data over a network, comprising the steps of:
testing a data transfer path to initially determine at least one capability of the transfer of video conferencing data across said path;
setting at least one parameter to an initial state based on the determined transfer capability, wherein the at least one parameter affects the transfer;
beginning transfer of the video conferencing data over said path;
detecting performance of the transfer of the video conferencing by evaluating a first performance measure that indicates whether a delay between receipt of a packet of the data and subsequent rendering of the packet exceeds a threshold;
modifying at least one parameter of the video conferencing data transfer based on the evaluated first performance measure; and
subsequently reevaluating the first performance measure of the video conferencing data transfer and modifying the at least one parameter based on the subsequently reevaluated first performance measure.

11. An apparatus configured to control a transfer of video conferencing data over a network between at least two electronic devices, the apparatus comprising:
means for setting at least one parameter to an initial state based on a set of capabilities for the transfer of video conferencing data between the at least two electronic devices, wherein the at least one parameter affects the transfer;
means for transferring at least a portion of the video conferencing data to a destination device over the network;
means for detecting performance of the transfer by evaluating a first performance measure that includes whether a delay between receipt of a packet of the data and subsequent rendering of the packet exceeds a threshold; and
means for modifying at least one parameter of the video conferencing data transfer based on the detected performance.

12. The apparatus of claim 11, wherein the means for detecting subsequently repeats the detecting of the performance and the means for modifying subsequently modifies the at least one parameter based on the subsequently detected performance.

13. The apparatus of claim 11, wherein the set of capabilities for the transfer of video conferencing data between the at least two electronic devices comprises a first set of one or more capabilities for the transfer of video conferencing data and a second set of one or more capabilities for the transfer of video conferencing data, the apparatus further comprising:
means for determining the first set of one or more capabilities for the transfer of video conferencing data at a first electronic video conferencing device,
means for receiving the second set of one or more capabilities for the transfer of video conferencing data at the first electronic video conferencing device.

14. A storage medium bearing instructions, wherein the instructions, when executed by one or more processors, cause the one or more processors to perform operations to control a transfer of video conferencing data over a network between at least two electronic devices, the operations comprising:
setting at least one parameter to an initial state based on a set of capabilities for the transfer of video conferencing data between the at least two electronic devices, wherein the at least one parameter affects the transfer;
beginning the transfer of video conferencing data over the network;
detecting performance of the transfer by evaluating a first performance measure that includes whether a delay between receipt of a packet of the data and subsequent rendering of the packet exceeds a threshold;
modifying the at least one parameter of the video conferencing data transfer based on the detected performance.

15. The storage medium of claim 14, wherein the operations further comprise:
subsequently reevaluating the first performance measure of the video conferencing data transfer; and
modifying the at least one parameter based on the subsequently evaluated first performance measure.

16. The storage medium of claim 14, wherein the set of capabilities for the transfer of video conferencing data between the at least two electronic devices comprises a first set of one or more capabilities for the transfer of video conferencing data and a second set of one or more capabilities for the transfer of video conferencing data; the operations further comprising:
determining the first set of one or more capabilities for the transfer of video conferencing data at a first electronic video conferencing device; and
receiving the second set of one or more capabilities for the transfer of video conferencing data at the first electronic video conferencing device;

17. A first electronic video conferencing device comprising:
a processor; and
a storage device encoding instructions, which when executed on the processor causes the processor to perform operations to control a transfer of video conferencing data over a network between the first electronic video conferencing device and at least a second electronic video conferencing device, the operations comprising,
setting at least one parameter to an initial state based on a set of capabilities for the transfer of video conferencing data between the first electronic video conferencing device and at least the second electronic video conferencing device, wherein the at least one parameter affects the transfer,
beginning the transfer of video conferencing data over the network;
detecting performance of the transfer by evaluating a first performance measure that includes whether a delay between receipt of a packet of the data and subsequent rendering of the packet exceeds a threshold;
modifying the at least one parameter of the video conferencing data transfer based on the detected performance.

18. The first electronic video conferencing device of claim 17, the operations further comprising:
subsequently reevaluating the first performance measure of the video conferencing data transfer; and
modifying the at least one parameter based on the subsequently evaluated first performance measure.

19. The first electronic video conferencing device of claim 17, wherein the set of capabilities for the transfer of video conferencing data between the first electronic video conferencing device and at least the second electronic video conferencing device comprise a first set of one or more capabilities for the transfer of video conferencing data and a second set of one or more capabilities for the transfer of video conferencing data;
the operations further comprising:
determining the first set of one or more capabilities for the transfer of video conferencing data at the first electronic video conferencing device,
receiving the second set of one or more capabilities for the transfer of video conferencing data at the first electronic video conferencing device.
